(19) United States
(12) Patent Application Publication
(10) Pub. No.: US 2017/0063114 A1
(43) Pub. Date: Mar. 2, 2017

(54) MULTI-PORT BATTERY CHARGING APPARATUS, SYSTEM AND KIT

(71) Applicant: Christian Fitch BRIERE, Mansfield Center, CT (US)

(72) Inventor: Christian Fitch BRIERE, Mansfield Center, CT (US)

(21) Appl. No.: 14/542,589

(22) Filed: Nov. 15, 2014

Related U.S. Application Data
(60) Provisional application No. 61/904,632, filed on Nov. 15, 2013.

(51) Int. Cl. H02J 7/00; B65D 43/16; B65D 25/28; B65D 25/10; B65D 1/34; B25H 3/02; B65D 43/22

(52) U.S. Cl. CPC H02J 7/0044; H02J 7/0021; B25H 3/02; B65D 43/163; B65D 43/22; B65D 25/10; B65D 1/34; B65D 25/2867

(57) ABSTRACT

The patent relates to a portable multi-port recharging apparatus, system and kit for charging a plurality of batteries with various configurations in an interchangeable, organized and portable enclosure. The apparatus, system and kit utilized one or more trays to accommodate various configurations of battery connection, charge requirements, and dimensions. Moreover, an induction charging system with an induction pad may be incorporated into apparatus and kit.

This patent application claims priority to U.S. Provisional Patent Application Ser. No. 61/904,632 entitled “MULTI-PORT BATTERY CHARGING APPARATUS AND SYSTEM” filed on Nov. 15, 2013, and the entire disclosure is hereby incorporated by reference herein.

### FIELD OF THE INVENTION

The patent relates to a portable multi-port recharging apparatus, system and kit for charging a plurality of batteries with various configurations in an interchangeable, organized and portable enclosure.

### BACKGROUND OF THE INVENTION

Battery technologies are being used in an increasing number of devices and in greater volumes. However, conventional battery technologies are beset by limited battery capacity that translates into less than optimal energy storage and use times. It is not uncommon, for example, in robotic device competitions for batteries to quickly discharge and the competitors keep multiple battery chargers and charged batteries “on deck” for when their primary battery runs low or out of energy. Robotics teams keep spare batteries being charged in order to replace spent batteries during the various rounds of competition. The problem with utilizing multiple battery chargers is in the cost of purchasing multiple chargers, the limited outlets generally available to plug in multiple charges at competition facilities, and the ability of conventional chargers to charge effectively and indicate the amount of charge.

Other examples where devices utilize power to discharge batteries quickly are power tools in trades and at job sites, whereby heavy use of cordless drills require swapping out batteries throughout the day. Still yet another example is with emergency responders who have need to keep wireless communicators online and charged in the field without outlets and the practicality of utilizing multiple chargers. The standard practice of bringing multiple battery chargers to the worksite also has disadvantages in the cost to purchase the required number of individual chargers to effectively swap out drained batteries and, at the worksite, the need for the chargers to be plugged into an AC outlet. Moreover, plugging into an AC outlet at the worksite may locate the charger a considerable distance away from the actual location of their need and use. From a perspective of time and convenience, as well as physical location, this situation suffers a number of problems that add to the labor cost of a project and other inefficiencies. Other problems with severe consequences can occur when there is a need to replace batteries such as, for example, in the medical responder field, where an inability to effectively transport their battery chargers to where the batteries are used can lead to delays and difficulties in disaster and/or emergency situations.

For example, conventional solutions heretofore involve moving all of the chargers, sometimes quite numerous, every time that they are needed in a different location. While a practical solution, moving all of the chargers requires time and physical effort to organize and setting up multiple chargers every time there is a need to move. Such time and effort can be a problem for competitions, trades and emergencies in the field, for example, the valuable time setting up battery chargers can be utilized to focus on the task at hand and, sometimes, mistakes in plugging in chargers results in no backup batteries charged when their batteries run out. As a result of these and other problems, there exists a long-felt need for a solution in a portable multi-port recharging apparatus and system or charging a plurality of batteries with various configurations in an interchangeable, organized and portable enclosure.

### SUMMARY OF THE INVENTION

It is an object of the present invention to provide an apparatus, system and kit of a portable multi-port recharging apparatus and system for charging a plurality of batteries in the device in a convenient, organized and portable enclosure having features and advantages of:
Compact
Universality and swappable interchangeable trays to improve space usage and organization
Lightweight (as possible)
Able to discharge smartly
Able to charge using connectors,
Able to charge without using connectors such as induction systems that have advantages when using in the field and other environment
Can have fast and slow charging options
Has metering/indicator options including a display device for each battery and a Wi-Fi connected computer implemented program (such as a mobile application for a Wi-Fi connected computing device) functioning to detecting power level remotely

It is an object of the present invention to provide a portable multi-port recharging apparatus that satisfies a long felt need in the marketplace that a variety of users need in a multi-battery solution that advantageously can be configured as follows:

1. Charging multiple batteries at once: Users want the ability to charge multiple batteries at once within one contained unit. Today, if one has multiple batteries, one likely has multiple chargers. While some multi-battery, single unit chargers exist in the market, they lack many of the other attributes that users will find attractive in the present embodiment of this application. Users want a multi-battery, single enclosure unit that has attributes as noted in the following text.

2. Convenience and Organization: Users want convenience and organization. The users might be able to put a bunch of chargers into a box and carry that with them, but that is hardly a meaningful solution for organizing your multiple battery charging solutions. Users want a simple enclosure into which they can plug their batteries for charging, storage, and portability. They want to be able to plug one electrical cord into the wall, not one for each of their chargers. They want the neatness of a consolidated unit and to be able to grab one enclosure and go.

3. Cost Effectiveness: Users want economy in their charging solutions. In general, battery technologies are relatively expensive ways to consume power. Battery energy, when purchased in the form of, say, non-rechargeable AAA batteries in the store, can be 10,000 times the expense of watt-for-watt power out of an electrical outlet and multiple times the expense of rechargeable batteries. When power is available, the user is to charge from electrical outlets to save money, and if not from those sources, then from rechargeable batteries. But rechargeable batteries require charging stations. So users want a flexible capability to charge as inexpensively as possible in any given instance, and to have the charging unit be smart about its use of what power it draws from for charging the batteries Likewise, users may already have invested in certain components of charging solutions, like AC adapters. Instead of buying an enclosure with this expense built in, users might like the option to use their existing AC adapters in the enclosure to save money.

4. Portability: Users want portability in charging multiple batteries at once with one contained unit. While one can charge multiple batteries with multiple chargers, this is woefully inconvenient when trying to transport said chargers to other locations and plug them in again. Users would love to have a single unit to carry. Simply, it is easier to take one unit to someplace else than ten units, if you have ten chargers. The convenience, organization, and portability offered by a single charging unit is preferred by users.

5. Power Source Independence: Users want independence of power source—such as for a remote control hobbyist application in which the hobbyist might go out to a field somewhere to fly battery-powered airplanes, and there are no electrical outlets for charging in the middle of the field. Many hobbyists have to keep their cars running to charge batteries, unnecessarily burning fuel and spending money inefficiently in the process. These users would love to have a unit with a high capacity battery store from which other batteries may be charged. Such a high capacity battery can be contained in the single enclosure for off-grid charging.

6. Battery and Charging Status: Users want accuracy in reporting on charge state of multiple batteries with one contained unit. Most batteries have no indicator of charge state. While one can find high end chargers that will groom and report on charge state in batteries, there are few, if any, multi-battery chargers that provide independent charging circuits in a single enclosure and report on the precise state of charge in each circuit. Users want to be able to look at a battery and determine its charge state in a very quickly in this increasingly connected world whereby users can utilize a Wi-Fi connection to detect the metered power and indicate it wirelessly on a Smartphone or other connected computing device.

7. Universal Commercial Solution: Users want universality of battery charging support too, where users might have different sorts of batteries they need to charge, and would want to do so with a singular enclosed unit. Since they may have made an investment in the core charging unit, they would love to be able to have a means to “swap trays” within the unit to be able to support different battery types. So a family might use the unit to charge recyclable batteries—AA, AAA, C, and D—during normal use, but swap in a tray for robotic batteries when the robotic competition comes around.

The same universality of battery charging support also applies to different batteries charged within one enclosed unit at the same time. It is not uncommon for robotic hobbyists, for instance, to need to charge 7.2V, AA, and AAA batteries for their competitions. These users would like to be able to organize, charge, store, transport and otherwise use these in one convenient enclosure. This would require the ability to have interchangeable modules within the tray system to support different battery types.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations.

FIG. 1 illustrates a perspective view of the portable multi-port recharging apparatus, system and kit invention shown with cover closed;

FIG. 2 illustrates a perspective view of the present invention, shown with cover open;

FIG. 3 illustrates a perspective view of the uniform battery predetermined tray configuration of the present invention, shown with cover open;

FIG. 4 illustrates a perspective view of the interchangeability of the present invention, shown with lid open with meter and charging batteries;

FIG. 5 illustrates a perspective view of the present invention, shown with cover open and a tray out of the main storage compartment;

FIG. 6 illustrates a perspective view of a customizable embodiment of the present invention;

FIG. 7 illustrates a top view of main compartment of the present invention;

FIG. 8 illustrates a top view of main compartment of a customizable embodiment of the present invention;

FIG. 9 illustrates a circuit diagram for the common bus in the main compartment in accordance with an embodiment of the present invention; and

FIG. 10 illustrates a circuit diagram of the electronic circuitry, display device, and metering in accordance with an embodiment of the present invention.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “Power Camel” refers to a portable multi-port recharging apparatus and system for charging a plurality of batteries in the device in a convenient, organized and portable enclosure. Power Camel™ also is a source identifier for a toolbox-based, multiple battery charging solution. The Power Camel has one or more of the following elements: a volt meter or other meter for measuring charge of the battery, a switch, female connector, male connector, power strip, and an enclosure, which can be configured as a box or utility tool box. The tool box can have a tray or other divider to form an upper and lower compartment.

The Power Camel, on its most basic level, is a toolbox designed explicitly to hold one or more of any number of interchangeable trays or drop-in box charging systems, each of which is capable of holding and charging any number of different batteries via within-tray modules. The tray is much like any tray that is found inside a toolbox—it would “sit” on the same support elements of the toolbox as a normal toolbox tray—except this has electronics and organization specifically for battery charging; in such a situation, there is usually space remaining below the tray for storage. For exceptionally large requirements—where larger or more components are needed for a charging situation—a box insert enclosure might be needed which would rest on the bottom of the box and consume the whole enclosure. Both are necessary embodiments of this invention as they help meet different practical and technical requirements for different market applications.

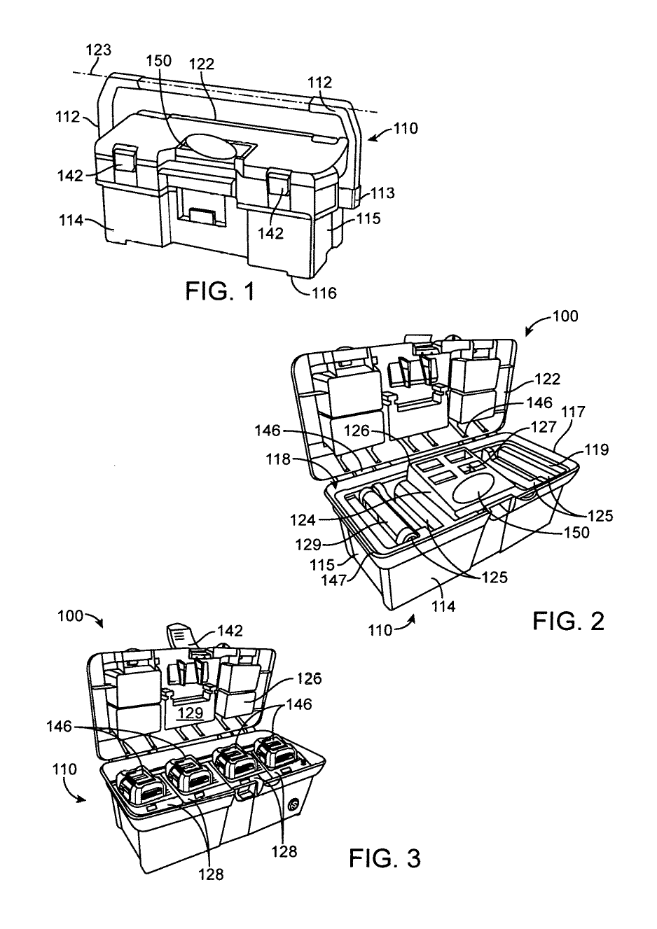

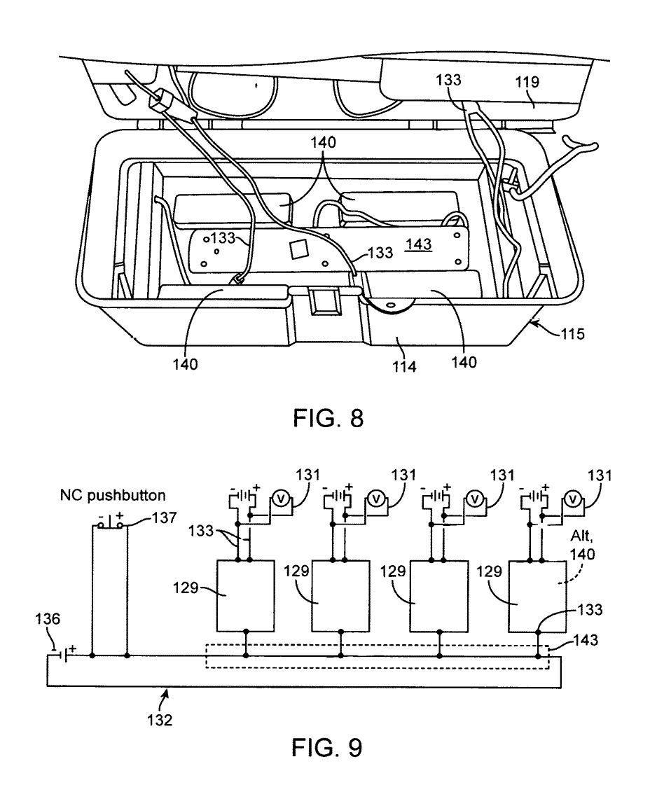

Referring to FIGS. 1 through 10, an assembly, system and kit 100 is configured for charging a plurality of batteries with various configurations in an interchangeable, organized and portable toolbox according to one embodiment of the present invention is shown in FIG. 1 and generally designated 100. The assembly, system and kit 100 is described in an embodiment of a toolbox assembly 110 includes a toolbox body 111, a handle 112, and mechanical connectors 113 connecting the handle 112 to the main toolbox body 111. The toolbox body 111 has peripheral walls forming a generally rectangular shape, with respective sidewalls 114, end walls 115, and a bottom 116. The toolbox body 111 may be rigid and manufactured from metallic, fabric or plastic materials. If formed of fabric, it may be advantageous to have a reinforcing elements (not shown) embedded in the fabric.

Referring to FIGS. 1-5, the toolbox body 111 has a centrally located main storage compartment 117 that is accessed from above. The storage compartment 117 is defined by interior walls 118 of the toolbox body 111, and is advantageously generally rectangular in top view. A tray or insert 119 is configured to be suspended by and between the interior walls 118 of the toolbox body 111 and above the storage compartment 117. The interior walls 118 forming the storage compartment 117 may advantageously have suitable mounting structures 120 and retaining means 121 attached thereto for securing transformers, ballast, adapters, circuit boards and other component parts in the storage compartment 117. The mounting structures can be molded flanges, struts and other means to form suitable structures in the interior walls 118 or bottom 116 of the storage compartment 117. The retaining means 121 can be straps, ties, fasteners or the like to secure objects and items placed in or on the supporting structures thereto. According to one embodiment, the storage compartment 117 may be closed via the tray or insert 119 with the cover or lid 122 that may be secured in place on one side by a hinge means and/or fastener(s) connecting the cover 122 to the tool body 111 and on another side by a clasps 142 on the outside of the toolbox body 111. The clasps 142 provide that the lid 122 may be secured to the remainder of the toolbox body 111. The clasps 142 and hinge means and/or fastener(s) 146 may be of any type known in the hinge art, clasp art, fastener art, or the like. Moreover, the toolbox body 111 and cover 122 may be made waterproof and/or water resistant by using one or more seal(s) 147 between seams and openings such as, for example, a seal 147 between the toolbox body 111 and cover 122 as well as any seals 147 openings (e.g. for outlets receptacles, etc.).

As illustrated in FIG. 1, The handle 112 provides a convenient means for carrying the toolbox assembly 110. The handle 112 is advantageously elongate, extending along a longitudinal axis 123 that may be straight or curved. The handle 111 is advantageously substantially rigid along its longitudinal axis 123, so as to provide a mechanical reinforcement to keep the longitudinal end walls 115 of the toolbox body 111 from collapsing inward when the toolbox assembly 110 is being carried by the handle 112.

As illustrated in FIGS. 2-5 and 6-8, the tray 119 includes a central area 124 and respective a predetermined configuration of bay portions 125 for receiving batteries to be charged. The central area 124 includes a grip structure 126 providing an expanded area designed to be gripped by a worker to access the main storage compartment 117. For example, the grip structure 126 may be molded as a raised edge, handle and suitable ridges or other grip enhancing surface features. The central area 124 may include suitable holes 127 for mating with the mechanical connectors 113 that connect to charging receptacles 128 of batteries 129 that need to be charged in a variety of configurations. These holes 127 are advantageously suitably reinforced, and are sized to provide a sliding fit with the connectors 130 as discussed further below. In an alternative embodiment, as illustrated in FIGS. 1, 4 and 5, the power camel assembly, system and kit 100 may be formed with system for induction charging 150 configured to be integrated into the tray 119 with an induction pad 151 located, according to one embodiment in FIG. 2, in the central area 124 and the connections and induction system components 152 may be located in the main storage compartment 117; and, according to yet another embodiment of FIG. 1, the induction pad 151 may be located on an outer surface 153 of the cover 122 so that charging of devices may occur with the cover closed as may be advantageous under environmental conditions and use in field.

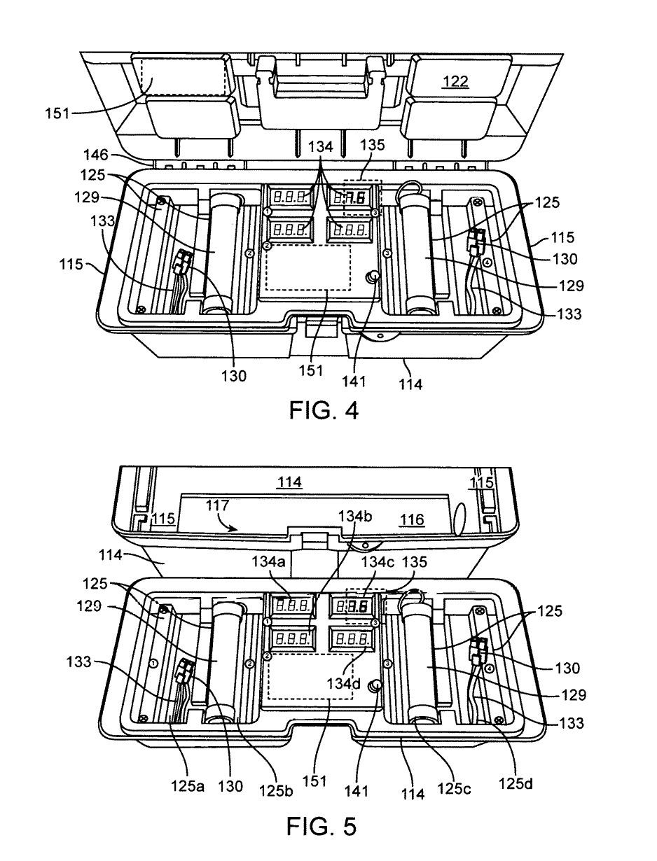

As is illustrated in FIGS. 4-5, 9 and 10, the toolbox assembly 110 also includes a meter 131 and associated electronic circuitry board 132 and connecting wiring 133. The meter 131 advantageously takes the form of a digital display 134 that may be formed in one embodiment from high intensity light emitting diodes (LEDs) 135, disposed in a portion of the central area 124. That is, the digital display 133 LEDs 135 are advantageously located slightly to one side of the central area 124 and apart from the side opened and closed typically by a worker when opening the lid 122. The digital display 133 LEDs 135 are oriented to display a voltage reading to the worker and associated with a predetermined bay 124 for charging the battery 129. As is illustrated in FIG. 5, each bay 125a, 125b, 125c and 125d can be associated with a meter 131 readout on digital displays 134a, 134b, 134c, and 134d advantageously to provide the user with an indication of the charge of a particular battery or batteries by actuating the switch button 141.

As is illustrated in FIGS. 4-5, 7, 9, and 10, control circuitry 132 and wiring 133 is configured to connect to the digital display 134 LEDs 135 and are selectively powered via a source of electrical power 136 and switch 137. The source of electrical power 136 can be an AC power source such as, for example, an electrical outlet (not shown). The main storage compartment 117 may be formed with an AC receptacle 136 adapted to receive the female portion 137 of a conventional extension cord or other plug that can plug into an AC outlet of a structure, vehicle or the like. In an alternative embodiment, the source of electrical power 136 can be one or more high capacity batteries, which are housed in the main storage compartment 117 that can provide a charge via receptacles 128 to the one or more batteries 129 in bays 125. Accordingly, in this alternative embodiment, the AC receptacle 136 may be used to connect and charge the one or more high capacity batteries 140 via the conventional extension cord connected to an AC outlet to charge the batteries 140 and then with the cord removed whereby the charged batteries 140 can be taken into the field to provide recharging of the batteries.

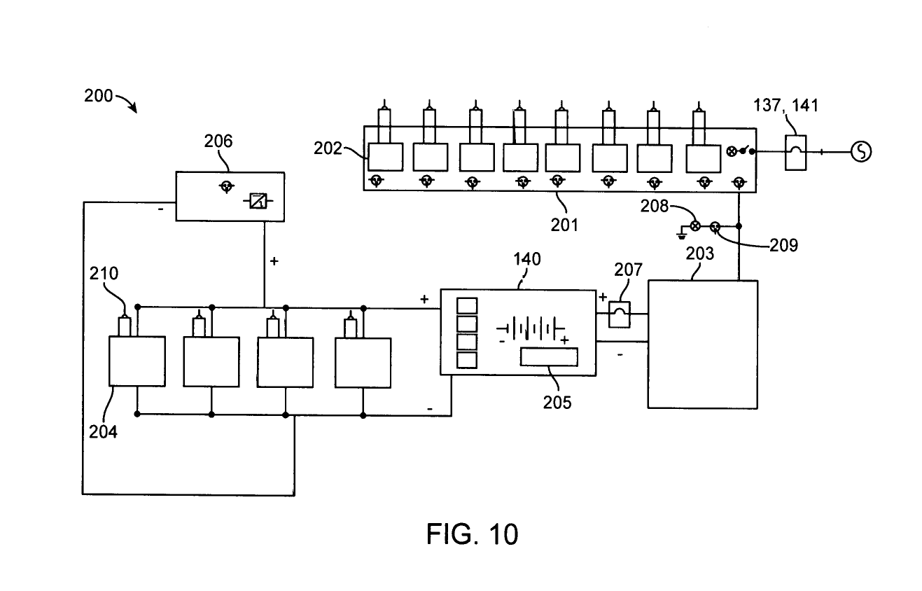

As is illustrated in FIGS. 4, 5, 9 and 10, a circuit switch 137 (FIGS. 9 and 10), as shown by switch button 141 (FIGS. 4 and 5) may be used for various purposes including the (1) to disconnect the electrical circuit 132 from the AC outlet to measure the true energization of the battery via the meter 131 as is provided by digital display 134. LEDs 135 and (2) to connect batteries 140 and may advantageously be disposed on an upper portion of the central area 124 and oriented to point upward, generally away from the main storage compartment 117. The switch 141 may be of any type known in the switch art. For example, the switch 141 may be of the momentary type (requiring constant pressure activate) or may be of the push/release type. The switch 141 controls the electrical power supply to the LEDs 135 from the battery 140, and thus the energization station of the LEDs 135. When closed, the switch 141 closes the electrical circuit 132 from the battery 140 to the LEDs 135. Accordingly, the user may selectively control the electrical connection via the switch 141 to disconnect the electrical circuit 132 from the AC outlet to measure the true energization of the battery via the meter 131 as is provided by digital display 134.LEDs 135

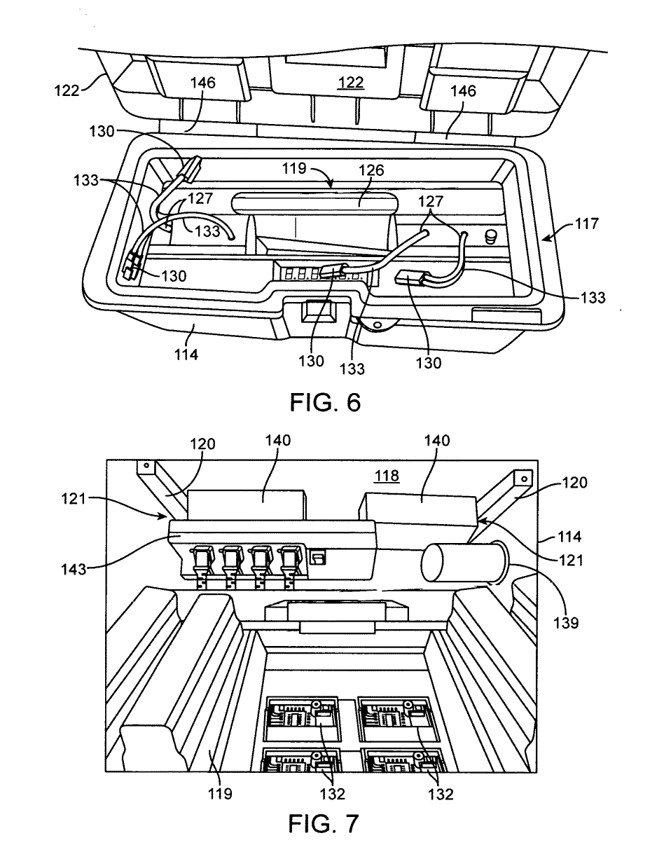

As above, the connections via connectors 130 to the batteries 129 in the toolbox assembly 110 may be formed in at least two embodiments: (1) as illustrated in FIGS. 2-5, as an integrated system of tray(s) 119 with built in connectors 130 for receptacles 128 for batteries 129 in each by portion 125; or (2) as shown in FIGS. 6-9, a tray 119 with holes to the main storage compartment 117 whereby a bus or multi-connector 143 is utilized and wires of the connectors 130 for receptacles 128 for batteries 129 are passed through holes 127 in the tray(s) 119. Accordingly the first (1) system is advantageous so that trays 119 can be manufactured for a variety of popular batter(ies) 129 in molded product with an efficient layout utilizing bay portions 125. In the embodiment of an integrated system of trays, there is little modification to the outer enclosure of the toolbox assembly 110 itself, but rather to the tray 119, whereby all components are adapted to be stored inside the interchangeable tray 119, multiple trays may be stacked in layers with connections being made to the components in the main compartment beneath them.

Accordingly, the second (2) system is advantageous for customization by the worker so that the tray(s) 119 can be configured for a variety of battery 129 types (e.g. sizes, specific connectors, etc.) being electrically connected to the source of electrical power 136 for power distribution to the batteries 129 via the connectors 130, electronic circuitry 132, and connective wiring 133. Configuring the tray 119 has bays 125 to contain all of the electronics, connectors, and other necessary components and to have these fit into the tray 119. Once components are fitted to the tray 119, the tray 119 can be inserted into the toolbox body 110, with the connectors 130 energized by the power distribution system.

A second format configures a toolbox with common components across a system of different trays and toolbox inserts such as, for example, power connections to the electrical grid, battery storage, etc. In this embodiment, the trays have fewer components, thereby reducing cost, while the toolbox would have more components with higher cost, but less cost than if the components were replicated across each tray/insert. This embodiment is suitable for battery users who expect to swap out many different types of batteries. The core toolbox components potentially in one embodiment could include a power distribution system that includes a male outlet, as part of the outer casing, which allows an extension cord to be plugged into the system and provide power from a power outlet of some kind. This system then distributes the power to the tray by way of an internal wire that transfers the power from this system to the tray. Another embodiment would have this power cable be on a spring loaded coil, much like a retractable vacuum cleaner cord. An option that the toolbox will have in this embodiment is for a large battery at the bottom which is able to store power when plugged into the electrical outlet on the wall, and then power the trays when the system offline (that is, is not plugged into a power outlet). Furthermore, in another optional arrangement, the consumer is able to include solar panels that are hooked into the power distribution system. This allows the batteries to be powered by solar electricity when regular power is either unavailable or unnecessary. Also, they can provide AC power to a number of devices beyond those that are specifically designed for the Power Camel, via USB and other power connectors found on the tray, box insert, or within-tray/unit modules.

Each of these embodiments of the toolbox assembly 110 of the Power Camel assembly, system and kit 100 utilizes a series of interchangeable battery trays 119. These trays 119 are designed such that each tray 119 will fit into the toolbox assembly 110, regardless of the type and/or variety of battery 129 sizes and configurations, or, alternatively, may be formed to hold multiple units of one specific kind of battery (e.g., DeWalt® rechargeable power tool batteries) as shown in FIG. 3 and associated bay portions 125, receptacles 128 for batteries 129 disposed in connectors 130 so as to recharge these (as shown in FIG. 3). In another embodiment, the tray(s) can be adapted to specific batteries but form more as an insert to maximize the space and number of batteries that can be recharged and/or transported.

Lastly, the tray 119 can take the form of a more universal bay portion 125 so that a worker can customize to accept off-the-shelf chargers or connectors for the type and/or variety of battery 129 sizes and configurations the worker uses and/or owns. Numerous benefits of this type of tray 119 include the customer does not need to buy additional charger assemblies, just the connector, and merely then uses the system for increasing their organization and mobility. Furthermore, chargers in this kind of a system are far easier to work with from an electrical point of view. With each battery on its own circuit, the tray can have a number of add-ons. In the VEX robotics market, for instance, this includes a voltmeter that provides a more accurate reading of the battery's charge a “must have” on competition day. In other markets, this could include the same voltmeter in addition to battery discharging, for the increased power of some NiCad batteries, and others. In some embodiments, the toolbox body 111 can be adapted with a notch 145 to allow for entry and egress of a power cord. In such an embodiment, each battery type would have its own self-contained tray (or box insert) charging and organization system. Each tray 119 would have standardized interconnects allowing for snapping in modules for charging all sorts of various battery types and devices.

The second type tray is, electrically, one unit. This tray will have a pre-installed electrical board that will handle all of the components needed for charging of the batteries. This will reduce the cost of the charging system. There are some add-ons that are shared by both systems, however both systems would have a “power disconnect” switch 137 to take the tray off charging power, in the case of emergency or checking the voltage of the tray, as the voltmeters are significantly thrown off by the power of the chargers (the goal is to measure the voltage of the battery, not the attached power source, be it the wall outlet or a large battery in the base of the unit). In addition, the trays that are designed to go into the off-the-shelf toolbox have male outlets into which extension cords can be plugged.

In addition, this toolbox is capable of holding a number of modules in compartments in its top and tray/insert systems. These modules vary in their capability but all are designed to slot into pre-slotted places in the toolbox, trays, or insert systems. These modules enable the user to buy a generic tray, for instance, and personalize that tray based on the batteries the user wishes to organize and charge. For instance, a user who wishes to charge AA and AAA batteries might purchase modules that could slot into the “lids feature” (on some toolboxes for storage of small parts); these same modules might slot into a tray along with other modules for other types of batteries. This allows a user to customize the toolbox for their use—both with an entire tray or box insert for one battery type, or by mixing these modules as desired for multiple battery types on one tray.

In an additional embodiment, the modules can contain popular connection ports—such as micro-USB, USB, or other cell phone, tablet, and other device charging connector—so that cables can be plugged directly into the system for charging of devices. Depending on the size and configuration of the toolbox, 110 volt (or other normal wall outlet power level) power can be supplied.

A wide range of other modules can be designed to work with this system, for example, many toolbox sizes are can be utilized so as to fit the various ranges of battery size (e.g., consumer batteries such as VEX Robotics batteries, commercial batteries such as, for example, rechargeable power tool batteries, and industrial-sized batteries and FIRST Robotics batteries).

Referring now to the specific circuitry of an embodiment of the present invention as illustrated in FIG. 9, the electronic circuitry 132 to connect the source of electrical power 136 to charge and re-charge each of the batteries 129 may take the form of connecting to (1) an AC power source from and AC receptacle 138 or (2) connecting to one or more high capacity batteries 140. The object of the electronic circuitry 132 in FIG. 9, is to recharge the batteries 129 and to display the progress of the recharging with meter 131 and digital display 134. As described herein, the switch 141 controls and removes the source of electrical power 136 (e.g. AC power source, receptacle 138, battery 140, etc.) to provide a readout of the electrical power supplied to the charging batteries 129, and thus the energization state the charging batteries 129. When closed, as shown in FIG. 9, the switch 141 closes the electrical circuit 132 from source of electrical power 136 to supply power to power to the charging batteries 129. When open, the switch 141 open the electrical circuit 132 the source of electrical power 136 is removed from the circuit. The meter 131 reads the voltage to be measured across connective wiring 133 via the potential across the positive and negative bias of the battery 129 and thus its energization state in the charging batteries 129. The meter 131 can be connected to a display for the user to read out, e.g. the digital display 134 provides a readout of the voltmeter by LEDs 135 in accordance with an embodiment of the present invention.

As is illustrated in FIG. 10, the electronic circuitry 200 to connect the source of electrical power 136 to charge and re-charge each of the batteries 129 may take the form of a surge-protector 201, for power distribution to the power chargers, one or more battery charger(s) 202 (e.g. for VEX 7.2 Volt battery used in robotics), a battery charger 203 (e.g. a 12.3 Volt Battery Charger for charging the base battery 140 (e.g. a LiFoPO4 3.2 Volt 15ah Battery to store long term power for mobile applications in the field without an AC power supply), an alternative battery charger 204 for a different type of battery (e.g. NiMH to charge a different variety of VEX 7.2 Volt battery or other high-speed-charging type of battery), a Protection Circuit Module 205 operating to open the circuit so as to cut of power if batteries begin to be overcharged, an AC Inverter 206 operating to provide direct electrical power (e.g. supply with DC output of 12 volt/5 volt from an AC 110 v/230 v outlet), the switch 137, 141 (i.e. Pushbutton) operating to for breaking the circuit to allow for more accurate detection of battery charge, a circuit breaker 207 functioning to provide circuit safety (e.g. a Temperature based circuit breaker to open the circuit for safety), an AC power outlet 208, a power indicator LED or light 209 functioning to show power entering the system as well as the charge of each battery, and a power cable 201 (female) that is useful for VEX 7.2 Volt batteries. Accordingly this configuration of one embodiment of the present invention is illustrated for the purposes of presenting the basic structures to charge a robotic VEX 7.2 Volt battery, other configurations for different types of batteries may construction without departing from the spirit and scope of the present invention. Moreover, the meter 131 can be connected to a Wi-Fi control circuit so as to provide a wireless signal representing values of the charge of the battery 129. A computer implemented program, such as a mobile application for the a device (i.e. smart phone, tablet, laptop, etc.) may be utilized to alert the user remotely the value(s) of the battery 129 charge (i.e. on a gradient from low to fully charged).

While certain configurations of structures have been illustrated for the purposes of presenting the basic structures of the present invention, one of ordinary skill in the art will appreciate that other variations are possible which would still fall within the scope of the appended claims. For example, a circuit board for the electronic circuitry 132 can be utilized to allow the apparatus and system to service a single Vex 7.2 volt 3000 mAh battery. Customer-owned chargers will be used to charge the Vex 7.2 volt 3000 mAh battery, as shown in FIG. 7. The circuit board 132 can have a connection plate or bus 143 for establishing multi-connections incorporated to allow a customer to connect a charger to the circuit to charge the Vex 7.2 volt 3000 mAh battery. The circuit board 132 can include a meter 131 (e.g. volt metering) and a disconnect switch 137, 141 so that a customer can easily check the voltage of the Vex 7.2 volt 3000 mAh batteries. Alternatively, an apparatus and system can be configured with individual volt meters 131 and disconnect switches 137, 141 for each Vex 7.2 volt 3000 mAh battery. Each battery 129 can be associated with an individual volt meter. Appropriate male/female connections and fastening of individual components for organization can be integrated into the charger system. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A compact toolbox assembly for charging one or more batteries, comprising in
combination,
a toolbox body comprising a main storage compartment, a plurality of trays; and a cover pivotally connected to said toolbox body; a hinge means pivotally connecting said cover to said toolbox body, said hinges connecting said cover to said toolbox body at first ends of said pair of side walls; said toolbox body having one or more clasps on a side wall of the toolbox body opposite said hinge means to provide for opening and closing of said cover to access said plurality of trays and said main toolbox body said cover when in the closed position resting upon an edge of each of said pair of side walls;
wherein said main storage compartment further comprising one or more mounting structures adapted to interior walls of said toolbox body so as to retain components when said cover is in its closed locked position, whereby components contained within said toolbox body are prevented from falling off or out of their respective mounting structures if said toolbox body is accidentally overturned, and
wherein said plurality of trays are configured with one or more predetermined bay portions to hold the one or more batteries when charging, each of said trays being configured in a predetermined configuration to provide a receptacle and a connector to each of the one or more batteries.

2. The toolbox assembly of claim 1 wherein said components are selected from the group comprising essentially of a circuit board, electronic circuitry, wiring, source of electrical power, and one or more high capacity batteries.

3. The toolbox assembly of claim 1 wherein said plurality of trays predetermined configuration provides the same a receptacle and a connector to each of the one or more batteries.

4. The toolbox assembly of claim 1 wherein said plurality of trays predetermined configuration provides a receptacle and a connector unique to each of the one or more batteries.

5. The toolbox assembly of claim 1 wherein said plurality of trays provides a bay portion of predetermined configuration and a receptacle and a connector connected to a source of electrical power components in said main storage compartment for the one or more batteries.

6. The toolbox assembly of claim 1 further including a meter for determining a charge of the one or more batteries by the voltage measurement or a current measurement.

7. The toolbox assembly of claim 7 further including a display device for displaying said meter output representing said charge of the one or more batteries by the voltage measurement or a current measurement.

8. The toolbox assembly of claim 1 further including a display device for displaying the progress of said charge of the one or more batteries.

9. The toolbox assembly of claim 1 wherein said tray further includes an induction pad for charging of the one or more batteries.

10. A kit for charging one or more batteries, comprising in combination, a toolbox body comprising a main storage compartment, a plurality of trays; and a cover pivotally connected to said toolbox body; a hinge means pivotally connecting said cover to said toolbox body, said hinges connecting said cover to said toolbox body at first ends of said pair of side walls; said toolbox body having one or more clasps on a side wall of the toolbox body opposite said hinge means to provide for opening and closing of said cover to access said plurality of trays and said main toolbox body said cover when in the closed position resting upon an edge of each of said pair of side walls;
wherein said main storage compartment further comprising one or more mounting structures adapted to interior walls of said toolbox body so as to retain components when said cover is in its closed locked position, whereby components contained within said toolbox body are prevented from falling off or out of their respective mounting structures if said toolbox body is accidentally overturned,
wherein said plurality of trays are configured with one or more predetermined bay portions to hold the one or more batteries when charging, each of said trays being configured in a predetermined configuration to provide a receptacle and a connector to each of the one or more batteries; and
a source of electrical power configured to be connected to said receptacle and said connector to each of the one or more batteries for re-energizing the charge of each of the one or more batteries.

10. box assembly of claim 10 wherein said components are selected from the group comprising essentially of a circuit board, electronic circuitry, wiring, and one or more high capacity batteries.

11. The kit of claim 10 wherein said plurality of trays predetermined configuration provides the same a receptacle and a connector to each of the one or more batteries.

12. The kit of claim 10 wherein said plurality of trays predetermined configuration provides a receptacle and a connector unique to each of the one or more batteries.

13. The kit of claim 10 wherein said plurality of trays provides a bay portion of predetermined configuration and a receptacle and a connector connected to a source of electrical power components in said main storage compartment for the one or more batteries.

14. The kit of claim 10 further including a meter for determining a charge of the one or more batteries by the voltage measurement or a current measurement.

15. The kit of claim 14 further including a display device for displaying said meter output representing said charge of the one or more batteries by the voltage measurement or a current measurement.

16. The toolbox assembly of claim 1 further including a display device for displaying the progress of said charge of the one or more batteries.
